(19) United States
(12) Patent Application Publication
(10) Pub. No.: US 2022/0170229 A1
(43) Pub. Date: Jun. 2, 2022

(54) GROUNDWORKS METHOD FOR A FOUNDATION FOR AN ONSHORE WIND TURBINE

(71) Applicant: CTE WIND CIVIL ENGINEERING, La Richardais (FR)

(72) Inventors: Alexander MARTIN, La Richardais (FR); Thanh Binh TRAN, La Richardais (FR)

(73) Assignee: CTE WIND CIVIL ENGINEERING, La Richardais (FR)

(21) Appl. No.: 17/437,180

(22) PCT Filed: Mar. 12, 2020
(86) PCT No.: PCT/EP2020/056699

§ 371 Date: Sep. 8, 2021

(30) Foreign Application Priority Data
Mar. 13, 2019 (FR) 1902552

(51) Int. Cl. E02D 27/42; F03D 13/20

(52) U.S. Cl. CPC E02D 27/425; E02D 2300/002; E02D 2300/0006; F03D 13/22

(57) ABSTRACT

A groundworks method for a foundation designed to form a foundation slab for an onshore wind turbine includes: excavating in the soil a depression intended to receive, on the one hand, an anchoring means which will be used to connect the mast to the future foundation and, on the other hand, the pouring of concrete to form said foundation after setting. According to the invention, the method further comprises digging a trench at the center of the depression, placing a compressible material in this trench, covering said material with a layer of concrete and waiting for it to set. A foundation is built for a wind turbine, by pouring concrete, the central part of which does not bear on the soil or barely bears on the soil. As a result, the pressure on the soil is increased and is delimited over a peripheral annular zone situated around its central part.

The present invention relates in particular to a groundworks method for a foundation intended to form a foundation slab for an onshore wind turbine.

When erecting a wind turbine on soil, a foundation needs to be built beforehand. The mast of the wind turbine is then fixed on this foundation, the nacelle and its rotor are mounted on top of the mast, and then the blade nose and the blades are mounted on the rotor.

In order to create the groundworks for the foundation of a wind turbine, it is known to dig an overall circular excavation in relatively flat soil, to pour a so-called blinding layer of concrete into the base of the groundworks which forms a separation between the soil and the foundation in order to make it easier to install wedges on a smooth surface and on which the framework constituting reinforcement steel is placed, to wait for the concrete to set, to assemble an anchoring means such as an anchor cage on the latter which will support the mast of the wind turbine, connect the mast of the wind turbine to its foundation, and transmit the loads between them, to install the reinforcement steel intended to reinforce the monolithic structure of the foundation, to make formwork for a volume of concrete to be poured, and then to pour the concrete into the formwork. The whole surface of the circular base of the foundation built in this way rests on the underlying soil. The foundation can be used after a period of twenty-eight days. When the anchoring means is an anchor cage, a metal ring, also called a tower pedestal in the profession, is installed thereon, the mast of the wind turbine is then mounted on the metal ring, and the mast is then fixed by being bolted in place. The nacelle is then assembled at the top of the mast and the other components of the wind turbine are mounted.

Against this background, the Applicant has sought to design an alternative operating procedure for carrying out groundworks for building a foundation for a wind turbine which can be sited on a piece of ground with a smaller surface area and which can be more economical, in particular in terms of the volume of concrete poured.

To this end, a groundworks method is proposed for a foundation designed to form a foundation slab for an onshore wind turbine, comprising a step of excavating in the soil a depression intended to receive, on the one hand, an anchoring means which will be used to connect the mast to the future foundation and, on the other hand, the pouring of concrete to form said foundation after setting; according to the invention, the method consists in:
digging a trench at the center of the depression,
placing a compressible material in this trench,
covering said material with a layer of concrete and waiting for it to set.

Groundworks produced in this way make it possible to build a foundation for a wind turbine, in particular by pouring concrete, and the central part of which does not bear on the soil or barely bears on the soil. As a result, the pressure on the soil is increased and it is delimited over a peripheral annular zone situated around its central part. This annular load distribution allows the foundation to withstand greater off-center loads. It is therefore possible to reduce the diameter of the foundation and reduce the volume of concrete involved in its manufacture. The uplift resistance of the foundation during the operation of the wind turbine is preserved.

According to an additional feature of the invention, the method consists in choosing a sheet, or a plurality of adjacent and/or superposed sheets, manufactured from expanded polystyrene, as the material.

This type of sheet is available in almost all industrial countries.

This sheet or sheets yields or yield under the weight of the foundation without transferring the load into the underlying soil.

According to an additional feature of the invention, the method consists, before the step of placing the compressible material in the trench, in pouring a layer of concrete into said trench.

This layer of concrete forms a separation between the soil and the foundation and creates a plane, horizontal, and smooth surface. This surface is advantageously used to position the feet of an anchoring means.

A foundation for an onshore wind turbine, comprising a block of concrete delimited by a cylindrical base topped by a truncated cone and the small base of which is situated above its large base, manufactured according to the abovedescribed method, also forms part of the invention.

The foundation is intended to be built in an excavation in order to form a foundation slab for an onshore wind turbine, the cylindrical base being delimited by a base wall; according to the invention, the base wall comprises a central disk surrounded by a plane ring and reaching the periphery of the foundation, arranged parallel to each other, the disk being arranged so that it is thicker than the ring.

The mass of the foundation and the mass and loads of the wind turbine after it has been installed on the foundation exert a pressure on the soil via the ring-shaped part of its base.

As a result, the pressure on the soil is increased and it is delimited over a peripheral annular zone situated around its central part.

According to an additional feature of the invention, the foundation includes an anchoring means.

The anchoring means such as an anchor cage, included in the foundation, serves to mount and fix the mast of the wind turbine.

An onshore wind turbine comprising a mast on top of which a nacelle and its rotor are mounted also forms part of the invention. The mast of the wind turbine is fixed on a foundation as described above.

Given a wind turbine of the same size, the wind turbine of the invention can be sited on a piece of ground with a smaller surface area compared with the siting of a conventional wind turbine.

Groundworks intended to receive the construction of a foundation to form a foundation slab for an onshore wind turbine, comprising an excavation in the soil which is made of a depression of suitable dimensions to receive, on the one hand, an anchoring means which will be used to connect the mast to the future foundation and, on the other hand, the pouring of concrete to form said foundation after setting also form part of the invention. The groundworks comprise, at the center of the depression, a trench, a compressible material arranged in said trench, a layer of concrete being arranged covering said material.

Such groundworks make it possible to build a foundation for an onshore wind turbine, in particular by pouring concrete, and the central part of which does not bear on the soil or barely bears on the soil. As a result, the pressure on the soil is increased and delimited over a peripheral annular zone situated around its central part. This annular load distribution allows the foundation to withstand greater off-center loads. It is therefore possible to reduce the diameter of the foundation and reduce the volume of concrete involved in its manufacture.

The abovementioned features of the invention, as well as others, will become more apparent upon reading the following description of an exemplary embodiment, said description being made with reference to the attached drawings, in which:

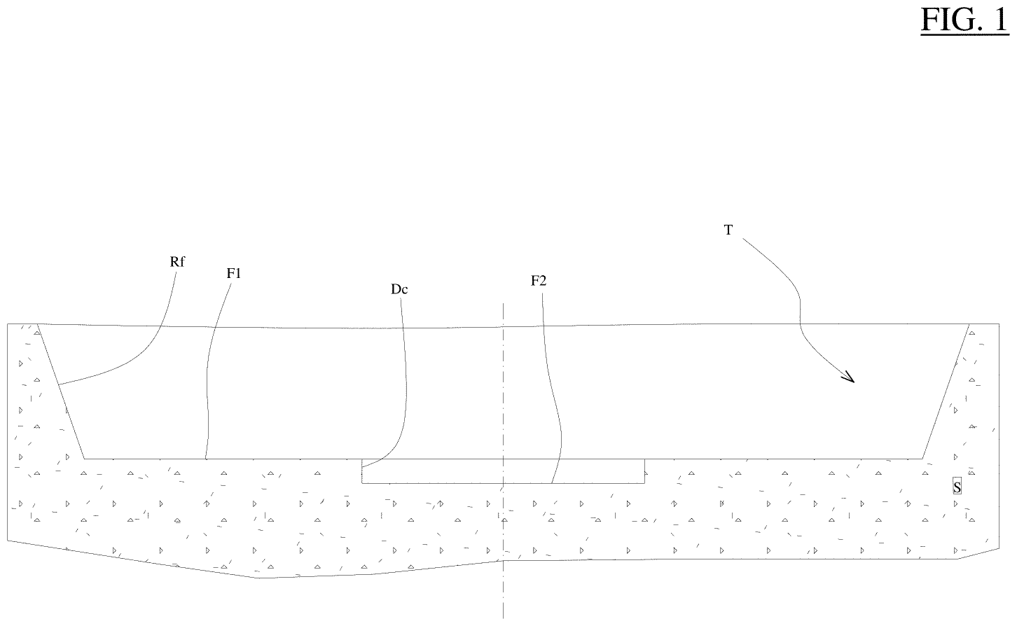

FIG. 1 shows a view in section of groundworks for an onshore wind turbine according to the invention,

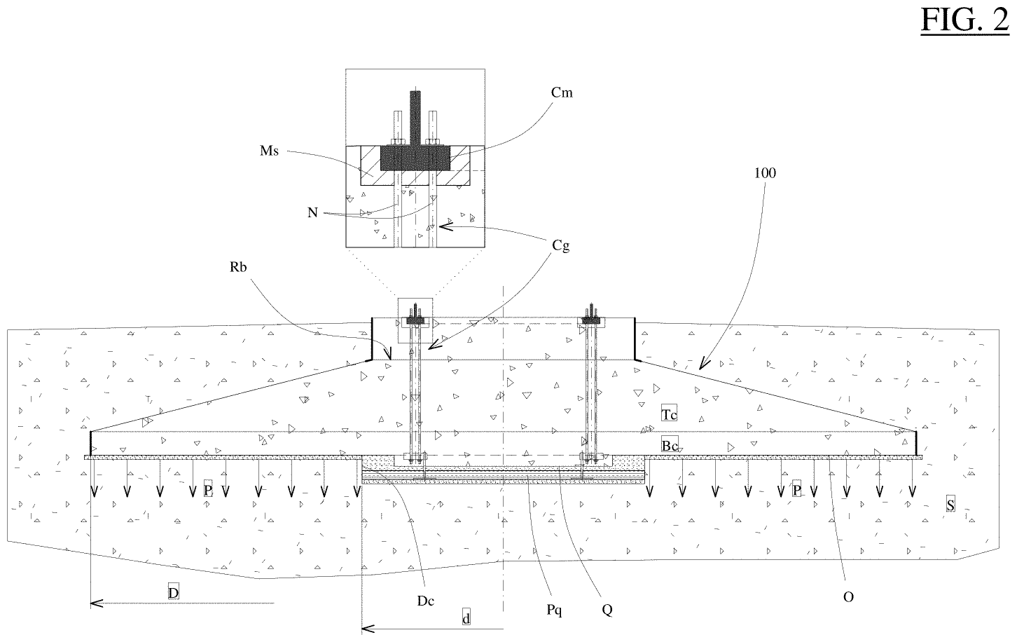

FIG. 2 shows a view in section of a foundation for an onshore wind turbine built in groundworks for an onshore wind turbine according to the invention,

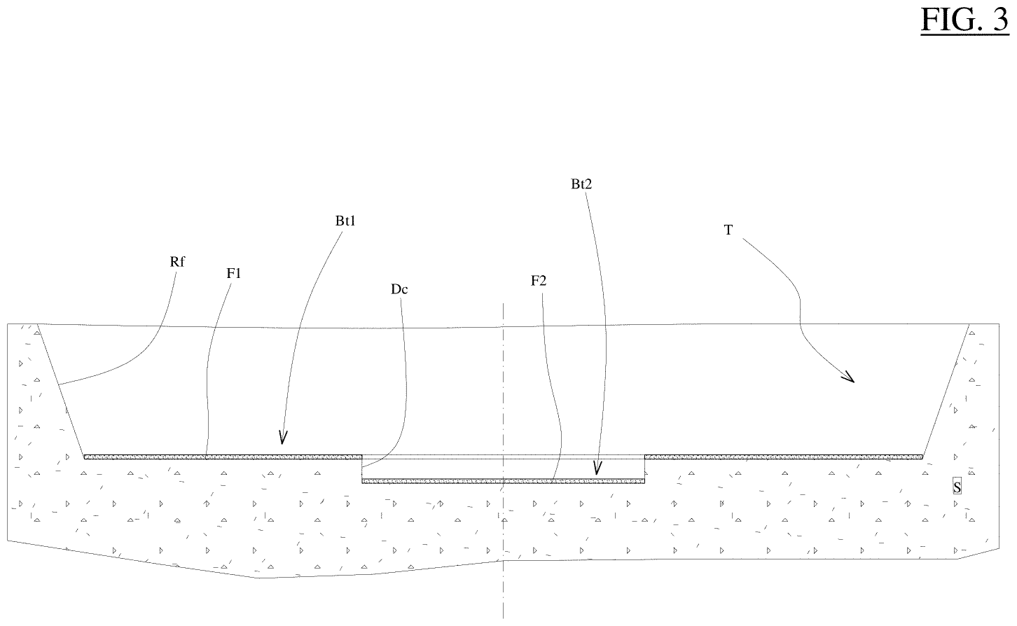

FIG. 3 shows a view in section of groundworks for an onshore wind turbine and the base of the groundworks of which is covered by a layer of concrete according to the invention,

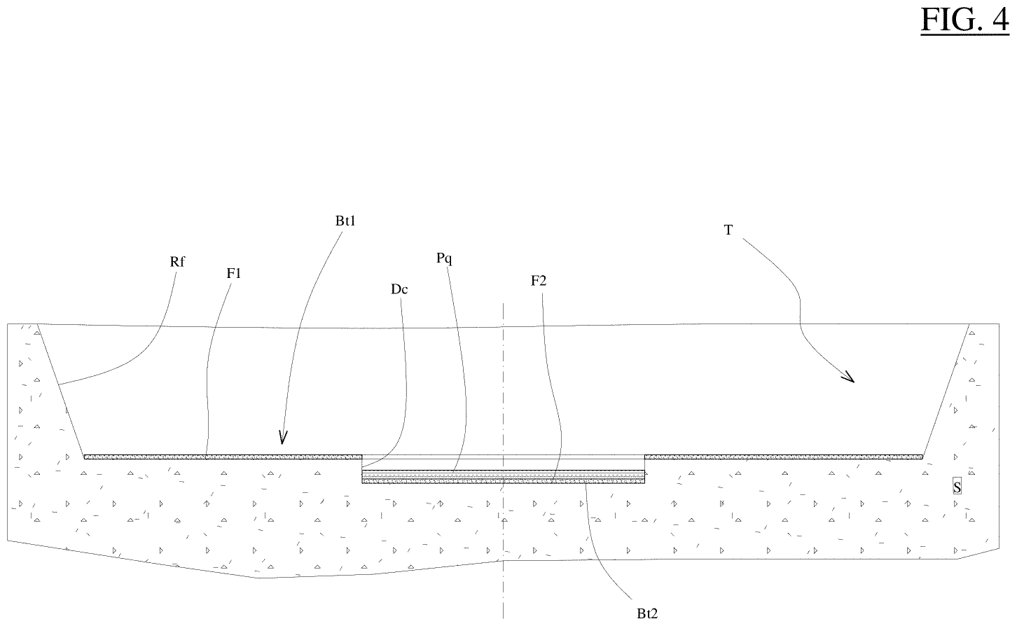

FIG. 4 shows a view in section of groundworks for an onshore wind turbine and the central part of the base of which is covered by a sheet manufactured from a compressible material according to the invention,

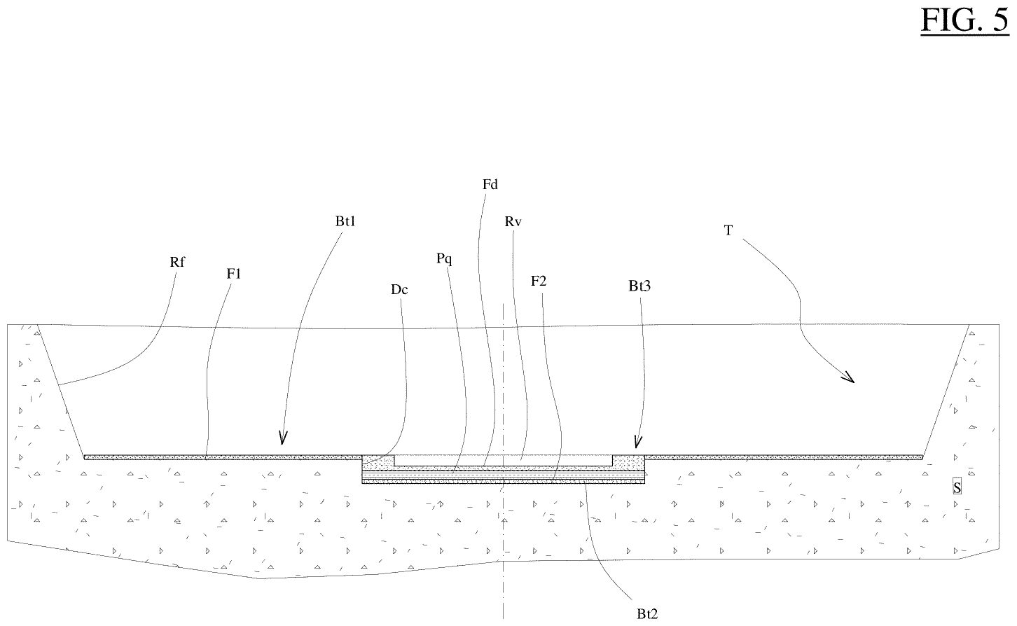

FIG. 5 shows a view in section of groundworks for an onshore wind turbine and the sheet manufactured from a compressible material of which is covered by a layer of concrete according to the invention,

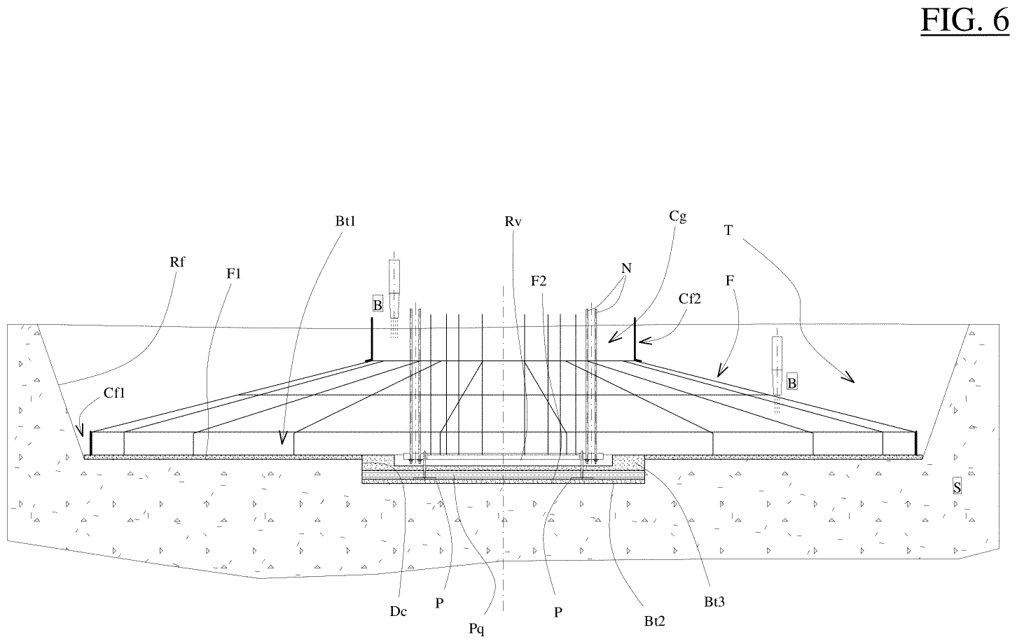

FIG. 6 shows a view in section of groundworks for an onshore wind turbine according to the invention and in which is placed an anchor cage intended to support the mast of a wind turbine in its future foundation, and reinforcement steel for the future foundation according to the invention, and

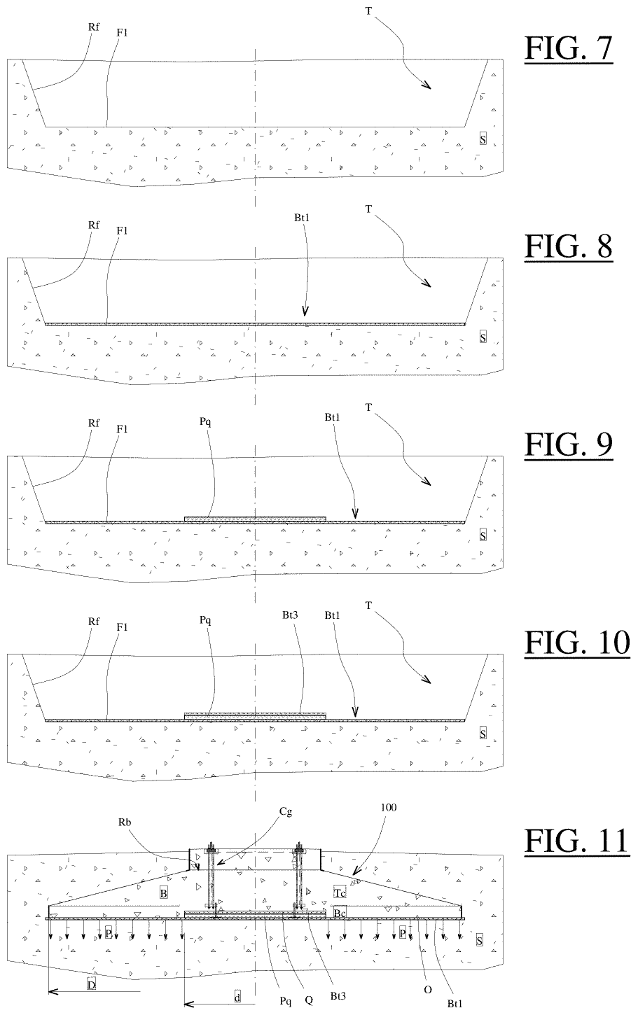

FIGS. 7-11 show views in section of groundworks with a flat base and the steps of building a foundation for an onshore wind turbine on these flat groundworks according to the invention.

The groundworks T shown in FIG. 1 are intended to receive a foundation for an onshore wind turbine.

The foundation 100 shown in FIG. 2 is built to form a foundation slab for an onshore wind turbine. It is intended to be sited on the erection site of the wind turbine in order to support it whilst it is being assembled and during operation. It must in particular bear the high mass of the wind turbine and withstand the stresses which it generates in particular when it starts up, when it is operating, and when it stops. During quasi-permanent operation (QP) of the wind turbine (see explanation on page 8), uplift of the foundation slab must be avoided.

Its geometry is defined by the presence of a cylindrical base Bc topped by a truncated cone Tc and the small base of which is situated above its large base. The cylindrical base Bc is defined by a base wall which is delimited in the invention by a disk Q at the center of the foundation and surrounded by a plane ring O which reaches the periphery of the foundation. The disk Q and the ring O are arranged parallel to each other, the disk Q being arranged in this FIG. 2 so that it is thicker than the ring O, in other words being situated lower than said ring.

Excavation work is required before undertaking the construction of the foundation.

The groundworks T consist, with reference to FIG. 1, in digging a depression Rf with a practically circular cross-section in relatively flat soil S and then digging a trench Dc in this depression Rf and at the center of the latter. For this purpose, a backhoe can be used to carry out these groundworks. This trench Dc preferably has a practically circular cross-section. The two bases F1 and F2 of the depression Rf and the trench Dc are plane and horizontal. The height of the depth of the depression Rf corresponds in practice to the height of the foundation. The depression Rf can also have, in order to simplify its construction, a polygonal cross-section defined by a multitude of faces instead of the circular cross-section.

The height of the depth of the trench Dc is in practice between 50 cm and 1 meter.

Then, with reference to FIG. 3, two so-called blinding layers of concrete Bt1 and Bt2, i.e. which are capable of forming a separation between the soil S and the foundation, are then respectively poured onto the two bases F1 and F2 of the depression Rf and the trench Dc in order to create a plane, horizontal, and smooth surface. The thickness of each layer of concrete Bt is in the order of 10 cm. The two layers Bt1 and Bt2 are separated by virtue of their situation on two different levels. Laying the layer of concrete Bt1 is a customary practice used in building a foundation for a wind turbine.

In the invention, a layer of a compressible material is placed in the trench Dc and on the layer of concrete Bt2 which has set beforehand. In FIG. 4, the material is a sheet Pq manufactured from expanded polystyrene which has been placed on the layer of concrete Bt2. A plurality of joined sheets can be used, taking into account the relatively large diameter of the trench Dc. Several levels of sheets can also be used to achieve the required thickness. The thickness of the sheet, of the sheets, or of the superposed sheets is between 10 and 30 cm, with a preferred value in the order of 20 cm.

Expanded polystyrene (EPS) currently conforms with the standard EN 13163 or its equivalent (for example, the standard ASTM C578), respecting the following criteria. The compressive stress with 10% deformation must be between 100 KN/m² and 120 KN/m² for a heavy foundation.

The following step consists, with reference to FIG. 5, in pouring a third blinding layer of concrete Bt3 on this sheet Pq. A plastic separation film can be placed on the sheet Pq (or on the material) before carrying out the pouring of the concrete. The level of this layer Bt3 at its periphery is coplanar with the level of the first layer of concrete Bt1. The thickness of this third layer of concrete Bt3 can reach 40 cm on its peripheral edge. This layer of concrete is intended, on the one hand, to form a separation between the sheet Pq and the foundation and, on the other hand, to form a plane, horizontal, and smooth surface to receive an anchoring means, such as an anchor cage and some of the reinforcement steel. The anchoring means can also be formed by a cylindrical wall commonly referred to as an anchor ring, cables connecting the mast of the wind turbine to its foundation. Only the example of the anchor cage is considered in this description.

A recess Rv formed, by example, with the aid of formwork (not shown) is dug in the central part of this third layer of concrete Bt3. The layer of concrete Bt3 is then defined by its upper face coplanar with the upper face of the layer of concrete Bt1 and a plane face forming its base Fd and which is arranged at a lower level.

By way of illustration, the diameter of the depression Rf can in practice be between 18 and 28 meters. The diameter of the trench Dc can in practice be between 6 and 14 meters.

Once the preparations for the groundworks T are finished, the following steps consist in building the foundation for the wind turbine in the groundworks.
With reference to FIG. 6, an anchor cage Cg which will be used as a footing for connecting the mast of the wind turbine to its foundation, transmitting to it the loads withstood by said mast, is placed at the center of the groundworks T. The anchor cage Cg comprises a plurality of bolts of a relatively great length, arranged vertically in a circle, in the use position of said anchor cage, and which are joined together at the bottom by a ring situated in the recess Rv. The anchor cage Cg has a geometry in the form of a cylindrical cage. The ring bears on the second layer of concrete Bt2 via feet P. These can be adjusted for the purpose of adjusting the vertical position of the anchor cage Cg. The recess Rv also serves to delimit a volume for embedding the ring and the bottom ends of the bolts and the framework of the reinforcement steel. The presence of the plane and horizontal layer of concrete Bt3 greatly facilitates the placing and positional adjustment of the anchor cage Cg.
Reinforcement steel F, made from a construction of a metal framework, is placed inside the anchor cage Cg and around the anchor cage Cg and in the volume defined for the foundation. The arrangement of this very dense reinforcement steel is designed by manual calculation or computer calculation in order to give the future foundation particular mechanical characteristics, making it capable of withstanding the loads that a wind turbine is caused to undergo during its lifetime which is currently between 20 and 30 years.
Supplementary operations such as introducing ducts for electrical connection of the wind turbine can also be performed at this stage.
Concrete B is then poured to fill the volumes of the cylindrical base and the truncated cone of the future foundation. In order to carry out this pouring of concrete, formwork Cf1 can be built around the volume of the cylindrical base of the future foundation. The specified waiting time of twenty-eight days is then observed such that the foundation created in this way can have the required mechanical strength.
In order to finish the construction of the anchor cage Cg, with reference to FIG. 2, a construction joint Rb can be made on the small base of the truncated cone of the foundation. In order to carry out this pouring of concrete B, formwork Cf2, which can be seen in FIG. 6, can be built around the volume of this construction joint Rb. In FIG. 2, a peripheral channel is provided at the top of this construction joint Rb and is intended to contain, after the concrete has set, a grouting mortar Ms and in which a metal collar Cm is placed which will form the base of the mast of the wind turbine. It is placed in such a way that the bolts N which constitute the anchor cage Cg can pass through it. After the mortar has dried, the metal collar Cm is clamped in the set grouting mortar Ms by tightening the nuts for tensioning the bolts. The anchor cage Cg is pretensioned during this bolting of the nuts.
The periphery is backfilled such that only the upper part of the anchor cage Cg remains visible.

The first section of the mast of the wind turbine is then mounted and fixed on this anchor cage, and then the second section and, if need be, the other sections is/are erected. It should be noted that the mast can be designed as a single section. The nacelle and its rotor are then mounted on top of the mast, and then the blade nose and the blades are mounted on the rotor.

In the invention, the mass of the foundation 100 and the mass and the loads to which the wind turbine is subjected exert a pressure on the soil which is no longer distributed in the form of a disk and instead in the form of a plane ring. Indeed, the compressible nature of the sheet Pq only transfers a tiny proportion of the load below the disk of soil situated below the trench Dc. The annular pressure exerted by the mass of the foundation 100 and the mass of the wind turbine which is assumed to be mounted, and with zero wind conditions, is indicated by the plurality of arrows P. The pressure exerted on the soil S is greater than that exerted by a foundation with the same diameter and the bearing surface of which is a solid disk.

Comparison of the Serviceability Limit State (SLS-QP)

SLS is the serviceability limit state.

QP is the quasi permanent loading condition of the wind turbine.

| | Circular shallow foundation | Annular shallow foundation |
|---|---|---|
| Under | Serviceability limit service SLS-QP with no | The same criterion for the annular |
| operational | uplift of the foundation, the latter is in | foundation: |
| load | 100% contact with the soil. This criterion is | Mᵣₑₛ − F_{z}/A < = 0 |
| (SLS-QP) | expressed with the following formula: | where: |
| | Mᵣₑₛ − F_{z}/A < = 0 | the modulus of inertia W of the annular |
| | where: | shape: = π (D⁴ − d⁴)/32D |
| | Mᵣₑₛ = resulting moment in the case of an | D is the diameter of the foundation |
| | operational load | d is the diameter of the material or the sheet |
| | F_{z} = vertical load | Pq in its trench Dc (see FIG. 2) |
| | the modulus of inertia W of the circular | A = π (D² − d²)/4 |
| | shape: = π D³/32 | therefore e < = (D² + d²)/8D = D/8 + d²/8D |
| | A = π D²/4 | |
| | Mᵣₑₛ/F_{z} = e (off-center loads) | |
| | e < = D/8 where D is the diameter of the | |
| | foundation | |

Thus, with the same diameter D of the foundation and with a diameter d of the non-loadbearing surface, it is possible to obtain a greater off-center load for an annular foundation.

It is then possible to reduce the diameter D of the foundation. As a result:
a foundation can be built on a piece of ground with a smaller surface area,
the volume of excavated soil required to dig the groundworks is reduced,
the volume of concrete is significantly reduced by between 10% and 18%.

In an alternative embodiment presented in FIGS. 7 to 11, the foundation is built on conventional groundworks with no trench.

In FIG. 7, the depression Rf dug in the groundworks T has a plane and overall circular base F1.

In FIG. 8, a layer of concrete Bt1 has been poured onto the base F1 of the depression Rf.

In FIG. 9, a compressible material such as in particular one of more adjacent and/or superposed sheets Pq manufactured from polystyrene has been placed on the set concrete Bt1 and at the center of the base F1.

In FIG. 10, a layer of concrete Bt3 has been poured onto the compressible material Pq. After it has set, an anchoring means and reinforcement steel, such as an anchor cage, are placed on the two layers of concrete Bt1 and Bt3 and in a similar operating procedure to that described above.

In FIG. 11, concrete B has been poured into formwork in order to form the foundation 100 and in an operating procedure similar to that described above.

The disk Q and the ring O are placed parallel to each other, the disk Q in this FIG. 11 being arranged recessed from the ring O, i.e. being situated higher than said ring.

1-8. (canceled)

9. A groundworks method for a foundation designed to form a foundation slab for an onshore wind turbine, comprising a step of excavating in the soil a depression intended to receive, on the one hand, an anchoring means which will be used to connect the mast to the future foundation and, on the other hand, the pouring of concrete to form said foundation after setting, the method comprising:
digging a trench at the center of the depression to a height of between 50 cm and 1 meter,
placing a compressible material in this trench, and
covering said material with a layer of concrete and waiting for it to set.

10. The method as claimed in claim 9, further comprising choosing a sheet or a plurality of adjacent and/or superposed sheets, manufactured from expanded polystyrene, as the material.

11. The method according to claim 9, further comprising, before the step of placing the compressible material in the trench, in pouring a layer of concrete into said trench.

12. The method as claimed in claim 9, further comprising pouring concrete into a formwork built in the depression in order to form a foundation.

13. A foundation for an onshore wind turbine, resulting from the groundworks method as claimed in claim 12, the foundation being intended to be built in an excavation in order to form a foundation slab for an onshore wind turbine, characterized in that it comprises a block of concrete delimited by a cylindrical base delimited by a base wall, the cylindrical base being topped by a truncated cone, the small base of which is situated above its large base.

14. The foundation for an onshore wind turbine as claimed in claim 13, characterized in that the base wall comprises a central disk surrounded by a plane ring and reaching the periphery of the foundation, arranged parallel to each other, the disk being arranged so that it is thicker than the ring.

15. The foundation for an onshore wind turbine as claimed in claim 13, including an anchoring means.

16. An onshore wind turbine comprising a mast on top of which a nacelle and its rotor are mounted, wherein the mast is fixed on a foundation as claimed in claim 13.

17. Groundworks intended to receive the construction of a foundation to form a foundation slab for an onshore wind turbine, comprising an excavation in the soil which is made of a depression of suitable dimensions to receive, on the one hand, an anchoring means which will be used to connect the mast to the future foundation and, on the other hand, the pouring of concrete to form said foundation after setting, wherein the groundworks comprises, at the center of the depression, a trench, of which the depth is between 50 cm and 1 meter, a compressible material arranged in said trench, a layer of concrete being arranged covering said material.
